(19) United States
(12) Patent Application Publication
(10) Pub. No.: US 2016/0084480 A1
(43) Pub. Date: Mar. 24, 2016

(54) THROWABLE TACTICAL LIGHT

(71) Applicant: Joseph GRASSO, Santa Clara, CA (US)

(72) Inventor: Joseph GRASSO, Santa Clara, CA (US)

(21) Appl. No.: 14/862,002

(22) Filed: Sep. 22, 2015

Related U.S. Application Data
(60) Provisional application No. 62/053,365, filed on Sep. 22, 2014.

(51) Int. Cl. F21V 15/01; F21V 33/00; F21V 23/00; F21V 23/04

(52) U.S. Cl. CPC F21V 15/012; F21V 23/0414; F21V 33/0076; F21V 23/009; F21V 23/0407; F21V 23/0492; F21Y 2101/02

(57) ABSTRACT

A tactical illumination device comprises an optically transparent and impact resistant housing, one or more high intensity light sources positioned within the housing, and a controller positioned within the housing, the controller being arranged and programmed to direct the light sources to emit light according to one or more modes after being thrown by a user against a hard surface.

### CROSS REFERENCE TO RELATED APPLICATIONS

This application claims priority to, and the benefit of, U.S. Provisional Patent Application No. 62/053,365 filed on Sep. 22, 2014, which is hereby incorporated by reference in its entirety and for all purposes.

### BRIEF DESCRIPTION

Embodiments of the present disclosure relate generally to tactical equipment. More specifically, embodiments of the present disclosure relate generally to tactical illumination devices.

### BACKGROUND

Nonlethal disorientation or temporary incapacitation of subjects is often accomplished using “flashbang” devices such as stun grenades or flash grenades. Such devices are non-lethal explosives which emit a blinding flash of light and/or a loud noise upon detonation, temporarily blinding or stunning those nearby. Incapacitated in this manner, subjects can be arrested or otherwise rendered harmless, and threats removed, with hopefully minimal injury to themselves, to others, and to surrounding property.

Flashbang devices, however, are not without their drawbacks. As explosive devices, the concussion from their blasts can still cause injury. Furthermore, the heat generated by such blasts poses a significant risk of igniting any nearby flammable materials, potentially causing damage to nearby property and people. Accordingly, continuing efforts exist to improve such devices.

### SUMMARY

The invention can be implemented in many different ways. In one exemplary embodiment, a tactical illumination device comprises an optically transparent and impact resistant housing, one or more high intensity light sources positioned within the housing, and a controller positioned within the housing, the controller being arranged and programmed to direct the light sources to emit light according to one or more modes after being thrown by a user against a hard surface.

The housing may have at least one substantially flat side. For example, the housing may have two opposing and substantially flat sides. The housing may also have any shape, such as a substantially cylindrical shape, a substantially pyramidal shape, or a substantially cubic shape.

The device may include one or more switches positioned at an exterior of the housing and in communication with the controller so as to be operable to direct the controller to select from among the one or more modes. These switches may include a switch that is operable to select a delay time after which the light sources are directed to emit light.

The modes may include a strobe mode in which the light sources are directed to emit rapid pulses of light, and wherein the one or more switches include a switch that is operable to select the strobe mode. The modes may also include a steady lighting mode in which the light sources are directed to emit light of substantially constant intensity, and wherein the one or more switches include a switch that is operable to select the steady lighting mode. The modes may further include a blinding mode in which the light sources are directed to emit light having higher intensity than light emitted in another mode different from the blinding mode, and wherein the one or more switches include a switch that is operable to select the blinding mode.

The device may further include a rigid frame positioned within the housing, the light sources and the controller being coupled to the rigid frame. The device may also include an electrical power source positioned within the housing and arranged to supply electrical power to the light sources.

The light sources may comprise high intensity light emitting diodes.

The device may further include one or more orientation sensors in electronic communication with the controller, the orientation sensors arranged to transmit an indication that a side of the housing is obscured.

In another embodiment, a tactical illumination device comprises an optically transparent and impact resistant housing having a plurality of sides, one or more high intensity light sources positioned within the housing so that at least one of the light sources faces each side of the plurality of sides, and a controller positioned within the housing. The controller is arranged and programmed to direct the light sources to emit light through each side of the housing, so that the device is arranged to emit high intensity light from each of its sides after being thrown by a user so that at least one side comes to rest upon a surface.

### BRIEF DESCRIPTION OF THE FIGURES

For a better understanding of the invention, reference should be made to the following detailed description taken in conjunction with the accompanying drawings, in which:

FIG. 1 is a cutaway isometric view of a tactical light constructed in accordance with embodiments of the invention;

FIG. 2 is a top view of the tactical light of FIG. 1;

FIG. 3 is a bottom view of the tactical light of FIG. 1;

FIG. 4A and FIG. 4B are isometric views of tactical lights constructed in accordance with other embodiments of the invention; and

FIG. 5A and FIG. 5B are isometric views of tactical lights constructed in accordance with further embodiments of the invention.

Like reference numerals refer to corresponding parts throughout the drawings. The various Figures are not necessarily to scale.

### DETAILED DESCRIPTION

One embodiment of the invention is a small, transparent, rugged and portable device containing high-intensity illumination sources that can be thrown into a dark area, where it will illuminate the area upon landing. One example is a device sized and shaped similar to a hockey puck, but with a transparent housing containing high-intensity light emitting diodes (LEDs) therein. The device can be set to emit bright flashes once thrown. Thus, for example, law enforcement individuals can throw one or more such devices into dark areas that contain armed suspects, temporarily blinding and thus incapacitating them, therefore allowing for neutralization of any threat without causing any physical harm. The device may be programmable to emit light of different durations and patterns, for use in various situations.

Embodiments of the present disclosure thus provide a light for use in tactical or combat-related situations, which is rugged enough for use in tactical or combat-related environments, yet is safe and nonlethal. The device is small and light yet rugged, and thus is as easy to use as a traditional flashbang grenade, yet provides significant advantages over such grenades. For example, it does not produce any explosion, thus posing no risk of fire or concussive damage. The device is also re-usable, unlike traditional flashbang grenades which can only be used once.

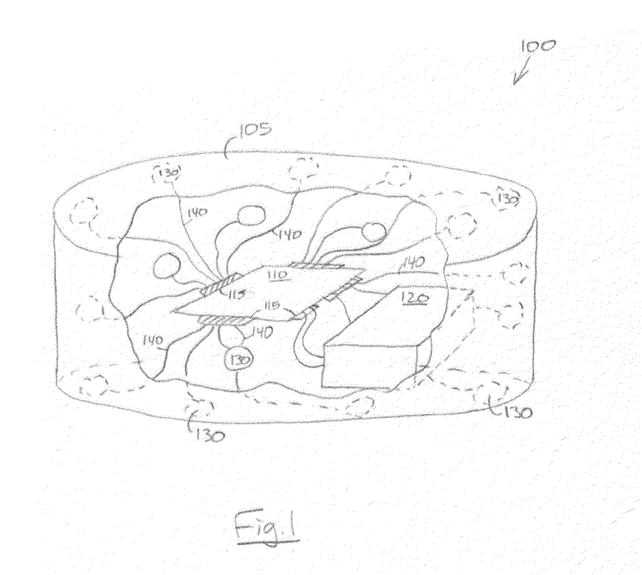

FIG. 1 is a cutaway isometric view of an illustrative tactical light constructed in accordance with one embodiment of the invention. Here, tactical light 100 has an outer shell 105 that holds a light source, battery, and controller within. More specifically, positioned within outer shell 105 is a controller 110, battery 120, and a number of illumination sources 130. The controller 110 is a printed circuit board (PCB) with an integrated circuit (IC) controller in communication with battery 120 and illumination sources 130 via interfaces 115. More specifically, electrical leads 140 connect the illumination sources 130 to interfaces 115 (and thus to controller 130). Similarly, the battery 120 is connected by wires to one interface 115, to supply power to both the controller IC and the illumination sources 130.

Any number and distribution of illumination sources 130 is contemplated. In one embodiment, each illumination source 130 is an LED. There is preferably a sufficient number of LEDs to render those nearby effectively unable to see for a short period of time. Furthermore, the LEDs or other illumination sources are preferably distributed somewhat uniformly across each surface of the tactical light 100, and at least across both the top and bottom surfaces, so that light is emitted substantially uniformly in every direction. In particular, illumination sources 130 may be distributed so that light is emitted omni-directionally, from every surface of shell 105. In this manner, the tactical light 100 may perform its intended function after being thrown, regardless of which of its sides that it lands on. The battery 120 should be of sufficient capacity to power the number of illumination sources 130 present.

The outer shell 105 is preferably made of a transparent, high-impact shock resistant plastic, so that the interior components are protected from damage during impacts or other forces. In this manner, tactical light 100 can still function and emit light even when thrown to the ground, stepped on, etc. The shell 105 should be of sufficient thickness to be able to withstand any of the shocks or impacts that may occur in field use. For example, it can be able to be thrown against a concrete wall or other rigid object without cracking or deforming to any degree that would harm any interior component. In particular, the outer shell 105 can be of sufficient strength to keep the light 100 able to function after being thrown a significant distance (such as 10-30 feet) and landing against a hard surface (such as a concrete floor). Similarly, it can be able to be stepped upon by a grown man, and preferably driven over by a vehicle, without cracking or deforming. Many conventional transparent high strength plastics can be used to make a sufficiently strong shell 105.

The outer shell 105 may be shaped so as to have a number of components or supports in its interior. For example, the interior of outer shell 105 may be made with recesses, supports, or platforms for attaching battery 120, illumination sources 130 and PCB 110 thereto or therein, and these components can be attached to such recesses/supports/platforms in any manner, such as by adhesive, screws, clasps, snap-fit attachments, or the like. Embodiments of the invention contemplate any such recess/supports/platforms or other ways of securely affixing components to the interior of shell 105 so that they do not detach during use.

The outer shell 105 is shown in FIG. 1 as having a cylindrical shape similar to that of a hockey puck. However, any size and shape is contemplated. In one embodiment, the outer shell 105 is a cylinder approximately 4 inches in diameter and 1 inch in height. However, larger lights 100 may be desired to illuminate larger rooms, for instance. Furthermore, the outer shell 105 may alternatively be shaped as a sphere, a cube, or any other desired shape.

The controller 110 can be a standard PCB securely coupled to the outer shell 105 in any manner sufficient to withstand shock or impact. The controller 110 includes a controller IC configured to control illumination of the lights 130 according to preprogrammed illumination modes, or according to user input as further described below. The controller 110 is in electrical communication with the battery 120 and illumination sources 130 via interfaces 115, so that the controller 110 receives power from battery 120 (both for its own operation and to supply power to the illumination sources 130) and controls the illumination of any of the lights 130.

The battery 120 may be removable as further described below, or may be integrally built into the light 100. The battery 120 may be disposable or rechargeable. In one embodiment, the battery 120 is a high powered lithium ion battery capable of storing sufficient charge to illuminate the lights 130 at a very bright level for at least several minutes, or at a lower level for an hour or more.

The illumination sources 130 may be high intensity LEDs, or any other light sources capable of emitting very bright light via battery power. The light sources 130 are distributed at least approximately uniformly throughout the interior of light 100, so that the light 100 emits light substantially uniformly in all directions. This allows the light 100 to provide its illumination functions regardless of which direction or orientation it lands in, after being tossed by the user.

The interior of light 100 may also contain reflective material to amplify light disbursement. Any such material and distribution thereof is contemplated, so long as it assists in distributing light regardless of which side of light 100 is facing up. For example, the controller 110 may be surrounded or partially covered with plastic coated with a reflective material.

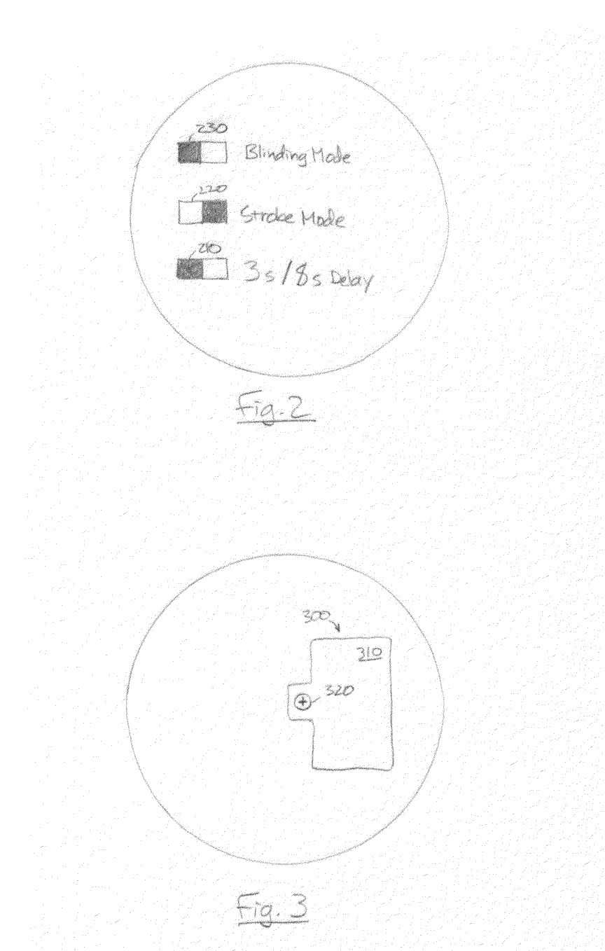

The tactical light 100 can be programmable with multiple different modes of operation. These modes can be automatically executed by the light 100, or selectable by the user. For example, the light 100 may contain motion sensors or accelerometers and may simply be programmed to go off, or emit light, a predetermined time after it senses that it is thrown. Alternately, the light 100 may allow the user to select from among various illumination modes. FIG. 2 is a top view of the tactical light 100 of FIG. 1, illustrating one embodiment allowing users to select from different illumination modes. Here, the light 100 has three switches 210-230 on its bottom surface, each for selecting certain modes or options. Any such modes or options are contemplated, and the modes shown in FIG. 2 are exemplary only. The example shown has switch 210 controlling a delay time, while switch 220 controls a strobe mode and switch 230 controls a blinding mode.

Switch 210 is a binary switch, allowing for switching between two states: a 3-second delay, or an 8-second delay. This provides the selected delay (3 or 8 seconds) from when the switch 210 is toggled to when light is emitted. This allows the user time to position tactically and prepare, after throwing the light 100 into a dark room. That is, the time delay gives the user time to prepare for the intense light to be emitted, e.g. allowing users time to shield their eyes, to hide so as to avoid being illuminated by the device, or the like. Any delay durations are contemplated, and embodiments of the invention can utilize any other delay times besides 3 and 8 seconds. That is, the invention contemplates toggling between any two or more predetermined delay times. Furthermore, embodiments of the invention can employ other methods of selecting a delay time. For instance, switch 210 can be a rotary dial with multiple delay times printed along its perimeter, allowing a user to simply rotate the dial to a desired delay time.

Switch 220 is a binary switch allowing users to switch between a strobe mode and a steady lighting mode. In strobe mode, light 100 “strobes”, or emits light as a series of quick, regularly-spaced pulses, while in steady lighting mode, light 100 simply emits light of constant intensity. Strobe mode has been shown to disorient individuals, and also interferes with an individual's ability to accurately locate the person deploying light 100. Steady lighting mode simply provides a steady light for illuminating the formerly-dark room. The modes of switch 220 are subject to the delay time of switch 210, so that the strobe flashes or steady illumination do not begin until the specified delay time (e.g. 3 or 8 seconds) has expired. Once the delay time has expired, the light 100 may simply strobe or emit steady light in uninterrupted manner until the battery 120 is depleted. A high powered lithium ion version of battery 120 may allow for over an hour of illumination. Alternatively, the controller 110 may be programmed to turn the lights 130 off after some specified amount of time, e.g. 15 minutes, to save battery life.

Switch 230 may operate as an on/off switch, turning a blinding mode on or off. In this mode, light 100 is programmed to emit a very bright light for a predetermined amount of time, such as 8-10 seconds (where any predetermined time duration is contemplated). The intensity of light in blinding mode is greater than the intensity of light otherwise. When the light is thrown into a dark room, the bright light of this blinding mode acts to temporarily blind those nearby, or at least ruin their night vision, allowing the user to move in and incapacitate suspects that cannot see. Blinding mode is subject to the delay time of switch 210 as well as the mode selection of switch 220. That is, the bright light of blinding mode is emitted only after the delay time set by switch 210, and the blinding mode light either strobes or is emitted at constant intensity according to the setting of switch 220. Blinding mode may also be followed automatically by other light settings. For example, controller 110 may be programmed so that, when set to blinding mode, the initial very bright light is automatically followed by a dimmer, constant light (such as the steady lighting mode of switch 220). This allows users such as law enforcement officers to move in and visually apprehend or incapacitate suspects once they are blinded.

The outer shell 105 may include access areas allowing users access to various internal components such as battery 120. FIG. 3 is a bottom view of the tactical light of FIG. 1, showing one such exemplary access area. More specifically, the bottom surface of light 100 has an access port 300 configured as a recess in outer shell 105, with a cover 310 affixed over the recess by an attachment mechanism such as a screw 320. This configuration is a standard battery compartment, allowing users to access the battery 120 for removal/replacement, or recharging as desired. Embodiments of the invention also contemplate alternate ways for allowing access to battery 120 or other internal components. For instance, instead of an access port 300, the light 100 may have a plug with retractable or foldout prongs, allowing the light 100 to be plugged into a wall outlet for recharging of battery 120. Other interfaces are also contemplated besides plugs, such as interfaces for connecting to automobile chargers or cigarette lighters, etc.

Operation and use of the light 100 will now be described. In an exemplary scenario, users such as law enforcement officers may encounter situations in which they are faced with one or more suspects, who may be armed and dangerous, hiding in a dark room. In this situation, the suspects have the tactical advantage, as they can see into the presumably-lighted area where the officers are, but the officers cannot see into the darkened room. To counteract this threat, the user may wish to toss a light 100 into the darkened room. If the officer wishes to blind the suspects, he or she would set switch 210 to the desired delay time, set switch 220 as desired, and set switch 230 to blinding mode. Once the switches are set as desired, the light 100 is tossed into the darkened room, where the LEDs 130 are illuminated after the delay time has been met. In this case, a very bright light would be generated, which either strobes or is constant depending on the setting of switch 220. This bright light would temporarily blind the suspects in the room, whereupon the blinding light would end after a predetermined period, and the officer can enter the room and arrest/incapacitate the blinded suspects.

If the officer instead simply wishes to illuminate the room, he or she would instead set switch 210 to the desired delay time, set switch 220 to constant light mode (strobe mode off), and set switch 230 to blinding mode off. The light 100 would then be tossed into the darkened room, whereupon the LEDs 130 would be illuminated after the delay time has been met, generating a constant light that is not as bright as in blinding mode, but is preferably sufficient to light up the room. In this manner, the officer can enter the room and visually locate the suspects.

If the officer somehow finds him or herself in a room with the suspects and wishes to safely escape, the officer can set switch 210 to the desired delay time, set switch 220 to strobe mode, and set switch 230 to turn off blinding mode. The light 100 can then be tossed into the room, whereupon it would begin to strobe once the delay time has passed. The officer can then escape the room while the light 100 is strobing, disorienting the suspects and preventing them from being able to accurately target the officer. In this manner, the officer can escape the room safely.

One of ordinary skill in the art will also recognize that other uses exist for the throwable lights of embodiments of the invention. For example, the light 100 can be used as a flashlight for illuminating any area. Indeed, the light 100 will work in any situation in which portable light is desired. The light 100 can also be used as an emergency alert device, such as a calling beacon or a locator, similar to a flare, for rescuers or emergency responders to quickly see and respond to.

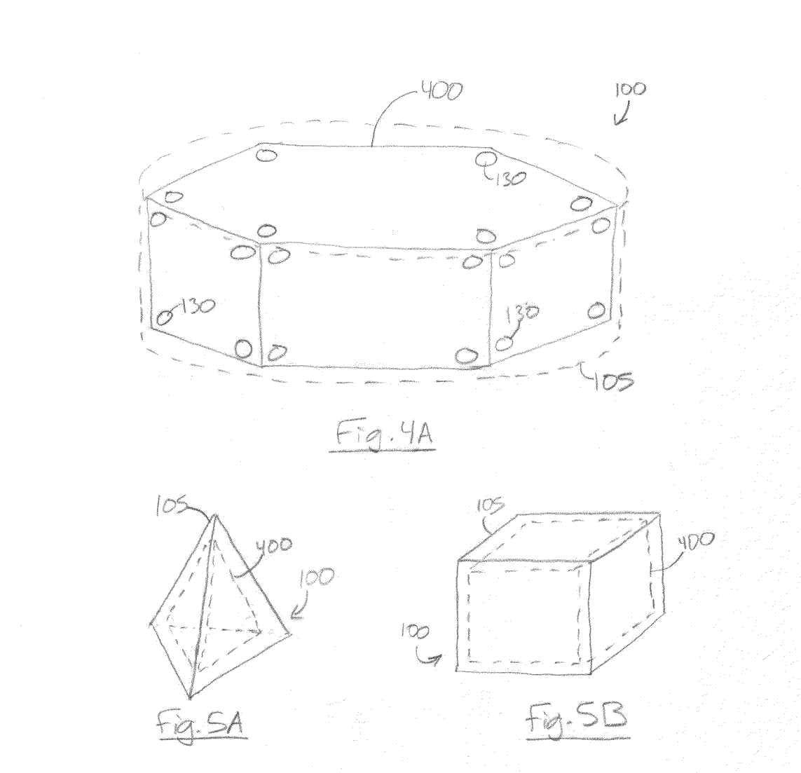

One of ordinary skill in the art will further realize that the light 100 can be constructed and shaped in any manner that provides a rugged and portable tactical light. That is, the invention includes other embodiments besides those explained above. As one example, FIG. 4A is an isometric view of a tactical light constructed in accordance with another embodiment of the invention, where the internal components of light 100 are affixed to an additional internal frame or protective member, rather than being directly affixed to the housing 105. Here, tactical light 100 has an outer shell 105 that is similar to that of FIG. 1, but which encloses a frame 400 within. The frame 400 is a rigid container or structure that supports, or encloses within, the above-described components of FIG. 1 that are contained within shell 105. That is, in this embodiment, controller 110 and battery 120 are located within the frame 400, and illumination sources 130 are installed at various locations along the outer surfaces of frame 400.

The light 100 may optionally include other components, without limitation. For example, the light 100 may include gravitational switches or other orientation sensors in electronic communication with the controller 110, and which signal to the controller 110 which side of housing 105 that the light 100 lands on after it is thrown, i.e. which side of housing 105 faces the ground and is thus obscured. The controller 110 may then be programmed to turn off any illumination sources 130 on that side, to save power.

FIG. 4B illustrates a tactical light constructed similar to that of FIG. 4A, but with a slightly different housing and with additional details of its construction shown. The light 100 of FIG. 4B has an outer shell 105 and frame 400 configured similar to previous embodiments, with illumination sources 130 attached to every side of the frame 400 so that light from at least one illumination source 130 can be seen regardless of which side of shell 105 the light 100 lands on. Housing 400 is shown as having illumination sources 130 and various other electronic components on its outer surfaces, but any of these components may alternatively be located within the housing 400 (as is, in this case, its battery). The switches 210, 220, 230 may be exposed by an opening or recess (not shown) in the outer shell 105.

The frame 400 is a rigid structure that acts to support and/or protect the components therein and thereon. In this embodiment, the frame 400 is a hollow housing with a hexagonal cross-section. The controller 110 and battery 120 are secured within frame 400, such as by screws, and are connected to illumination sources 130 affixed to the exterior. The illumination sources 130 may be placed anywhere along the exterior of frame 400, but it may be preferable for at least one illumination source 130 to be affixed to each side of frame 400, so that they will be visible regardless of the orientation of light 100. The frame 400 is a rigid, impact-resistant structure made of, for example, a metal such as steel or aluminum, or a sturdy plastic, and may be of any shape that fits within and is readily attached to shell 105. The various components 110, 120, 130, as well as any others that may be desired, such as interfaces 115, leads 140, and any other electrical or electronic components, may be located anywhere within or on the frame 400.

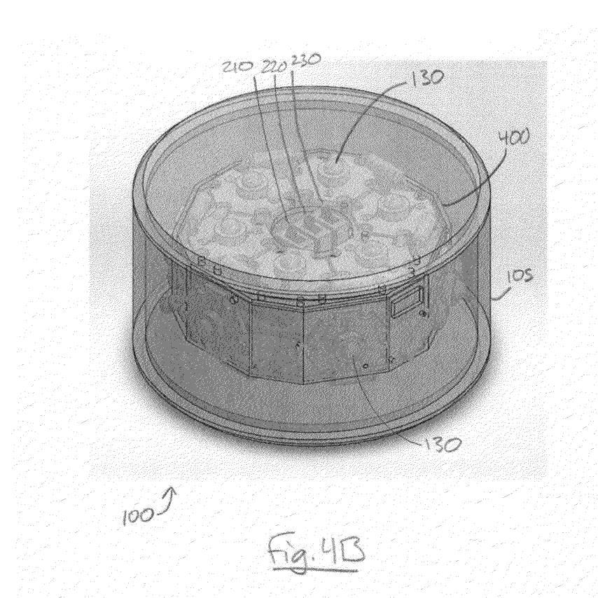

The outer shell 105 is also not limited to the shape shown in, for example, FIG. 1, but may be of any other desired shape. FIG. 5A and FIG. 5B are isometric views of tactical lights constructed in accordance with further embodiments of the invention, illustrating some of these alternate shapes. In particular, FIGS. 5A and 5B illustrate lights 100 with outer shells 105 that are shaped as a pyramid and as a cube, respectively. Such shapes have flat surfaces that prevent excessive rolling when the lights 100 are tossed onto the ground, and always land so that at least some surfaces, and their associated illumination sources 130, face upward/outward. The lights 100 may employ an interior housing 400 as shown, or may instead have their various internal components coupled to the shell 105, as in FIG. 1. Regardless of whether an interior housing 400 is employed, illumination sources 130 may be distributed within any of the outer shells 105 disclosed herein so that light is emitted from every surface of each outer shell 105. In this manner, users may toss a light 100 without regard for how it may land, and the light 100 will always land with some of its sides facing away from the surface upon which it lands, whereupon light will be emitted in all directions.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed.

Many modifications and variations are possible in view of the above teachings. For example, the tactical light of embodiments of the invention may be made in any shape and size, and may be made of any material that is sufficiently transparent and of high enough strength to withstand tossing against hard surfaces, being stepped on, driven over, and the like. The embodiments were chosen and described in order to best explain the principles of the invention and its practical applications, to thereby enable others skilled in the art to best utilize the invention and various embodiments with various modifications as are suited to the particular use contemplated. Also, individual features of any of the various embodiments or configurations described above can be mixed and matched in any manner, to create further embodiments contemplated by the invention.

What is claimed is:

1. A tactical illumination device, comprising:
an optically transparent and impact resistant housing;
one or more high intensity light sources positioned within the housing; and
a controller positioned within the housing, the controller being arranged and programmed to direct the light sources to emit light according to one or more modes after being thrown by a user against a hard surface.

2. The device of claim 1, wherein the housing has at least one substantially flat side.

3. The device of claim 2, wherein the housing has two opposing and substantially flat sides.

4. The device of claim 3, wherein the housing has a substantially cylindrical shape.

5. The device of claim 2, wherein the housing has a substantially pyramidal shape.

6. The device of claim 2, wherein the housing has a substantially cubic shape.

7. The device of claim 1, further comprising one or more switches positioned at an exterior of the housing and in communication with the controller so as to be operable to direct the controller to select from among the one or more modes.

8. The device of claim 7, wherein the one or more switches include a switch that is operable to select a delay time after which the light sources are directed to emit light.

9. The device of claim 7, wherein the one or more modes include a strobe mode in which the light sources are directed to emit rapid pulses of light, and wherein the one or more switches include a switch that is operable to select the strobe mode.

10. The device of claim 7, wherein the one or more modes include a steady lighting mode in which the light sources are directed to emit light of substantially constant intensity, and wherein the one or more switches include a switch that is operable to select the steady lighting mode.

11. The device of claim 7, wherein the one or more modes include a blinding mode in which the light sources are directed to emit light having higher intensity than light emitted in another mode different from the blinding mode, and wherein the one or more switches include a switch that is operable to select the blinding mode.

12. The device of claim 1, further comprising a rigid frame positioned within the housing, the light sources and the controller being coupled to the rigid frame.

13. The device of claim 1, further comprising an electrical power source positioned within the housing and arranged to supply electrical power to the light sources.

14. The device of claim 1, wherein the light sources comprise high intensity light emitting diodes.

15. The device of claim 1, further comprising one or more orientation sensors in electronic communication with the controller, the orientation sensors arranged to transmit an indication that a side of the housing is obscured.

16. A tactical illumination device, comprising:
an optically transparent and impact resistant housing having a plurality of sides;
one or more high intensity light sources positioned within the housing so that at least one of the light sources faces each side of the plurality of sides; and
a controller positioned within the housing, the controller being arranged and programmed to direct the light sources to emit light through each side of the housing, so that the device is arranged to emit high intensity light from each of its sides after being thrown by a user so that at least one side comes to rest upon a surface.

17. The device of claim 16, wherein the housing has a substantially cylindrical shape.

18. The device of claim 16, wherein the housing has a substantially pyramidal shape.

19. The device of claim 16, wherein the housing has a substantially cubic shape.

20. The device of claim 16, further comprising one or more switches positioned at an exterior of the housing and in communication with the controller so as to be operable to direct the controller to select from among the one or more modes.

21. The device of claim 20, wherein the one or more switches include a switch that is operable to select a delay time after which the light sources are directed to emit light.

22. The device of claim 20, wherein the one or more modes include a strobe mode in which the light sources are directed to emit rapid pulses of light, and wherein the one or more switches include a switch that is operable to select the strobe mode.

23. The device of claim 20, wherein the one or more modes include a steady lighting mode in which the light sources are directed to emit light of substantially constant intensity, and wherein the one or more switches include a switch that is operable to select the steady lighting mode.

24. The device of claim 20, wherein the one or more modes include a blinding mode in which the light sources are directed to emit light having higher intensity than light emitted in another mode different from the blinding mode, and wherein the one or more switches include a switch that is operable to select the blinding mode.

25. The device of claim 16, further comprising a rigid frame positioned within the housing, the light sources and the controller being coupled to the rigid frame.

26. The device of claim 16, further comprising an electrical power source positioned within the housing and arranged to supply electrical power to the light sources.

27. The device of claim 16, wherein the light sources comprise high intensity light emitting diodes.

28. The device of claim 16, further comprising one or more orientation sensors in electronic communication with the controller, the orientation sensors arranged to transmit an indication that one of the sides is obscured.
